(19) United States
(12) Patent Application Publication
(10) Pub. No.: US 2023/0034779 A1
(43) Pub. Date: Feb. 2, 2023

(54) SERVICE MESH FOR COMPOSABLE CLOUD-NATIVE NETWORK FUNCTIONS

(71) Applicant: Intel Corporation, Santa Clara, CA (US)

(72) Inventors: Cunming LIANG, Shanghai (CN); Jiayu HU, Shanghai 31 (CN); Jingjing WU, Shanghai (CN); Qi FU, Shanghai (CN); Zhirun YAN, Shanghai (CN); Hongjun NI, Shanghai (CN); Xiuchun LU, Shanghai (CN); Fan ZHANG, Limerick (IE); Haiyue WANG, Shanghai (CN); Pan ZHANG, Beijing (CN)

(21) Appl. No.: 17/963,662

(22) Filed: Oct. 11, 2022

(30) Foreign Application Priority Data
Sep. 12, 2022 (CN) PCT/CN2022/118286

(51) Int. Cl. G06F 9/48; G06F 9/54

(52) U.S. Cl. CPC G06F 9/4881; G06F 9/543

(57) ABSTRACT

Examples described herein relate to during runtime of at least one process, cause the one or more processors to execute the at least one process according to the determined thread model and in-process with a sidecar, wherein the sidecar is to communicate with a service mesh to communicate with one or more microservices of a cloud native application.

### RELATED APPLICATION

This application claims the benefit of priority to Patent Cooperation Treaty (PCT) Application No. PCT/CN2022/118286 filed Sep. 12, 2022. The entire content of that application is incorporated by reference.

### BACKGROUND

Microservice architecture is an architectural approach to build applications composed of independently deployable software components. A service mesh provides a dedicated infrastructure layer that controls service-to-service communication over a network based on Hypertext Transfer Protocol (HTTP), Hypertext Transfer Protocol Secure (HTTPS), and/or remote procedure call (RPC). Microservices and service meshes can implement Cloud-native applications.

Some applications do not utilize a service mesh to provide communications among microservices. For instance, some network functions (e.g., next generation firewall (NG-FW), load balancing (LB), Network Address Translation (NAT), and gateway (GW) or other functions that utilize Ethernet, Multiprotocol Label Switching (MPLS), Segment Routing over IPv6 dataplane (SRv6), Transmission Control Protocol/Internet Protocol (TCP/IP), etc.), media transportation (e.g., GW that utilizes Real-time Transport Protocol (RTP), Society of Motion Picture and Television Engineers (SMPTE) ST 2110, etc.), 5G (e.g., Radio Access Network (RAN) and User Plane Function (UPF)).

### BRIEF DESCRIPTION OF THE DRAWINGS

FIG. 1 depicts an example of application deployments.

FIG. 2 depicts an example system.

FIG. 3 illustrates an example implementation on a platform.

FIG. 4 depicts an example of deployment of a sidecar in-process with a microservice.

FIG. 5 depicts an example of services deployments based on call graphs.

FIG. 6 depicts an example of 13fwd call graph.

FIG. 7 shows an example use of protobuf to transmit meta-data.

FIG. 8 depicts an implementation of dependent services.

FIG. 9 depicts an example process.

FIG. 10 depicts an example system.

FIG. 11 depicts an example system.

### DETAILED DESCRIPTION

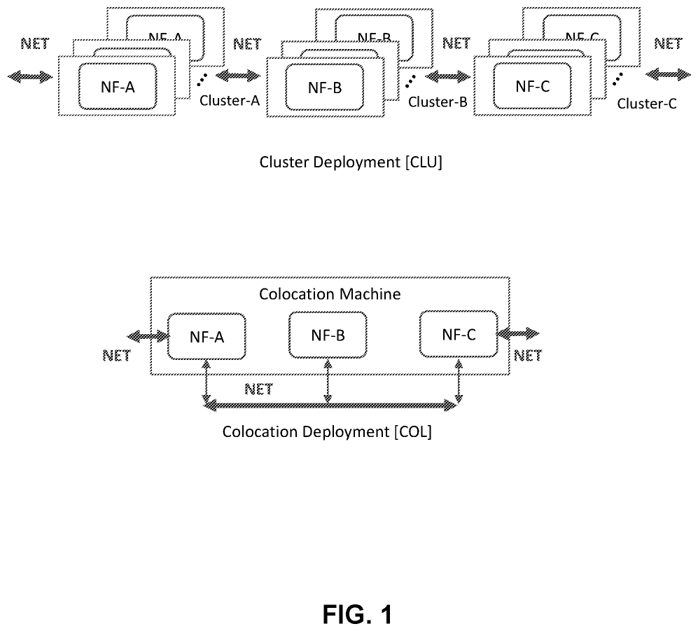

FIG. 1 depicts an example of application deployments. Cloud-Native applications can be deployed on a hybrid cloud such as in a data center, edge server, on-premises, or other scenarios. In a data center, applications (e.g., NF-A, NF-B, and NF-C) can be deployed within a single cluster (CLU). Various different clusters can be composed to be a chained function and communicate using a network (NET). A co-location deployment (COL) can include a deployment of applications in a single platform executed by one or more central processing unit (CPU) sockets. Co-location deployment can occur at an edge or on-premises deployment and utilize a switch (NET) provides communication among applications (NF-A, NF-B, NF-C).

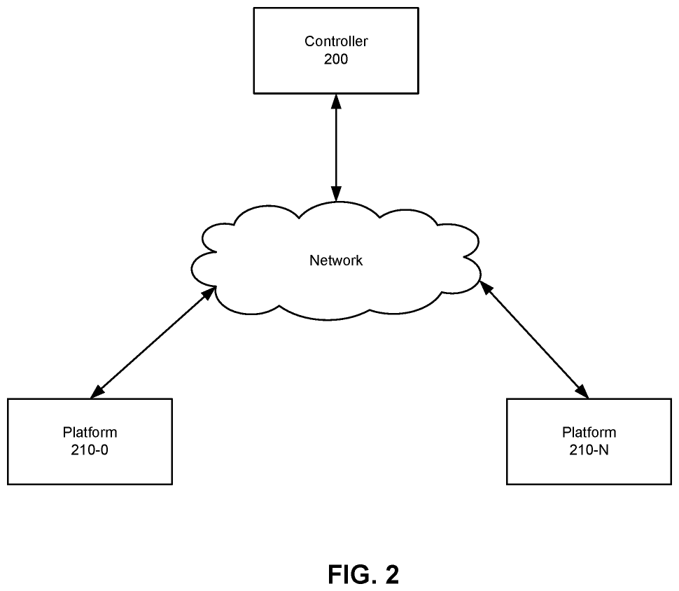

FIG. 2 depicts an example system. Controller 200 can cause execution of network functions by microservices on one or more of platforms 210-0 to 210-N. Network functions can include one or more of: firewall, load balancer, router, gateway, reverse proxy, or others. Controller 200 can issue dependency graphs for microservices deployed for execution on one or more of platforms 210-0 to 210-N to one or more of platforms 210-0 to 210-N. Dependency graphs can indicate data dependencies among microservices executed on a same platform or different platforms.

Based on instructions from controller 200, platforms 210-0 to 210-N can execute threads, applications, processes, microservices, containers, virtual machines, or other virtualized execution environments. As described herein, microservices can be deployed in-process with a side car on one or more of platforms 210-0 to 210-N. As described herein, a thread model binding can occur in a runtime stage, on one or more of platforms 210-0 to 210-N, instead of compiling stage.

Microservices can communicate using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can include a service on a network that an application can invoke. A microservice can include one or more of: polyglot programming (e.g., code written in multiple languages to capture additional functionality and efficiency not available in a single language), or lightweight container or virtual machine deployment, and decentralized continuous microservice delivery. Various examples can utilize an orchestrator to deploy microservices for execution such as Kubernetes, Docker, OpenStack, Apache Mesos, and so forth.

Service mesh and sidecars can perform service-to-service communication, perform request routing, and provide fault tolerance. Side cars can perform microservices management tasks, such as service discovery and distributed tracing of services. The sidecar can provide communications among distributed services and using different programming languages. The sidecar can perform a communication proxy and translate dependency graphs across languages. A microservice can communicate with the side car to communicate with a service mesh to communicate with one or more microservices.

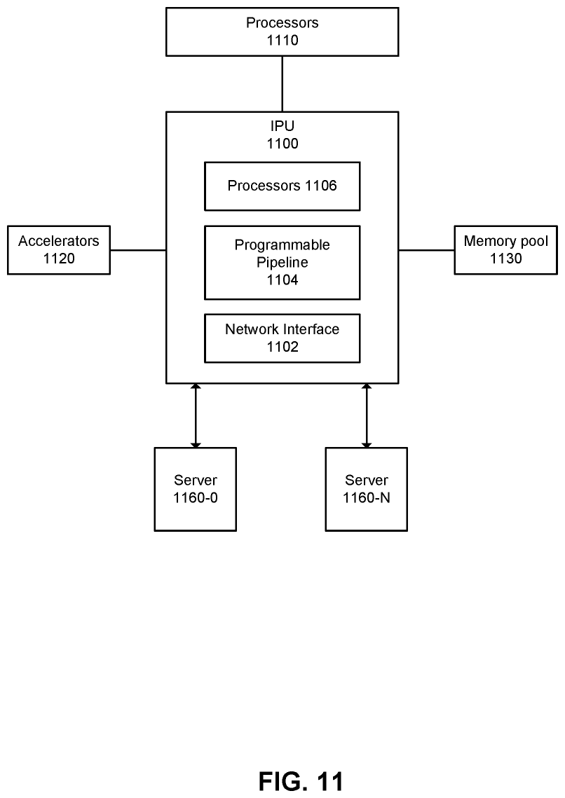

For example, controller 200 and platforms 210-0 to 210-N, where N is an integer of value 1 or more, can include one or more processors; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more network interface devices; one or more servers; one or more computing platforms; a composite server formed from devices connected by a network, fabric, or interconnect; one or more accelerator devices; or others. In some examples, a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. Various examples of one or more of controller 200 and platforms 210-0 to 210-N are described at least with respect to FIGS. 11 and 12.

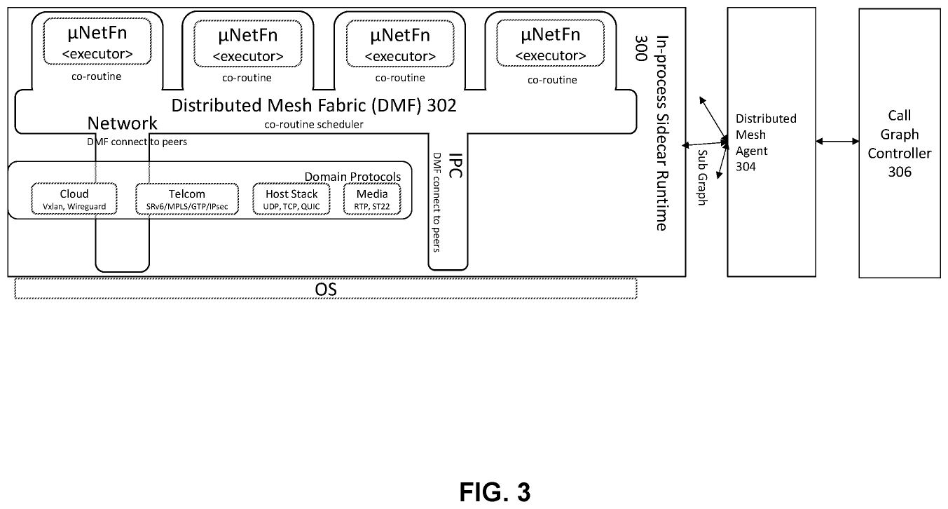

FIG. 3 illustrates an example implementation on a platform. Microservices (e.g., μNetFn) can be composed to perform various network functions. For example, network functions can include one or more of: firewall, load balancer, router, gateway, Network Address Translation (NAT)), and/or others. Microservices can be deployed in-process with one or multiple in-process sidecar runtimes 300. For example, a microservice and sidecar can execute in-process by executing on a same core, in a same process, in a same thread, in a same container, or others.

Within at least one runtime, a unified distributed mesh fabric (DMF) 302 can compose a representation of dependencies among microservices (co-routines) according to a call graph representation from Distributed Mesh Agent 304. For example, call graph controller 306 can provide a call graph indicating microservices and dependencies among microservices and Distributed Mesh Agent 304 can generate a call graph for microservices executed on the platform.

As described herein, DMF 302 can perform thread model binding of microservices in a runtime stage instead of a compiling stage based on a hardware and/or software environment of a platform that executes the microservices. In some examples, DMF 302 can provide communications among microservices across platforms executing on different servers using domain protocols and/or provide communications among microservices within a same server, but different process or container by using inter-process communication (IPC) mechanisms such as shared memory IPC, etc. As described herein, meta-data (not depicted) can be used to provide data to and from microservices executing on a same platform or executing on different platforms. Microservices can be deployed for execution on an operating system that can execute on different platforms such as an edge server, switch server, or data center.

References are made to microservices can instead refer to one or more of threads, applications, processes, containers, virtual machines (VMs), microVMs, or other virtualized execution environments.

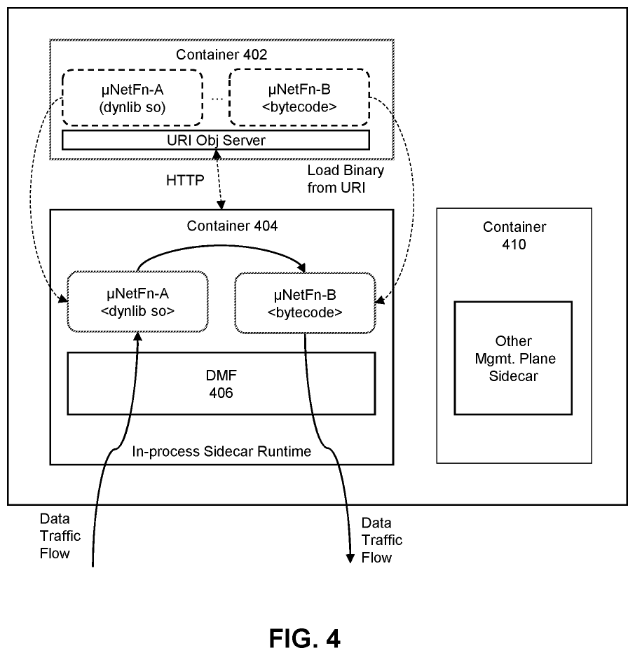

FIG. 4 depicts an example of deployment of a sidecar in-process with a microservice. In this particular example, a Kubernetes (K8S) Pod, or a service instance, executed on a single platform, can include the sidecar deployed in-process with a network function service container 402 and container 404. Container 402 and URI object server can provide independent deployable modular binaries of μNetFn-A and μNetFn-B to container 404 during runtime of container 404. For example, μNetFn-A can provide a dynamic library (dyn-lib) whereas μNetFn-B can provide a bytecode. For example, μNetFn-A can provide a dynamic library (dyn-lib) of load balancer whereas μNetFn-B can provide a bytecode of a NAT. For example. Container 404 can load, compile, and run modular binaries of μNetFn-A and μNetFn-B (e.g., dyn-lib loader, WASM Ahead-Of-Time (AOT), eBPF AOT, etc.). Container 404 can fetch and load modular binaries from service container 402 according to a call graph representation from a call graph controller.

In-process sidecar runtime can provide distributed mesh fabric (DMF) 404 for a domain specific data plane. Deployment of sidecar in-process with binaries of a network function service container can provide independence of execution of network function service container from a platform that executes the network function service container. Microservices can execute in-process with a sidecar runtime by sharing a same process space by executing on the same logical cores, share memory, share virtual memory address space, and share cache data. Microservices can execute in-process with a sidecar runtime by executing on a same core, in a same process, in a same thread, in a same container, or others. A logical core can be represented by a number of physical cores and number of threads that execute on the number of physical cores. Local calls can be made among microservices and sidecar runtime instead of remote procedure calls (e.g., Java's Remote Method Invocation (RMI), Microsoft COM).

Container 410 can include a management (mgmt) plane side car to provide telemetry of service discovery, lifecycle management, and others.

Microservices can be deployed for execution on different platforms with varying hardware and software capabilities according to co-location or clusters. Varying hardware capabilities can include CPUs, accelerators, memory devices, storage devices, input/output (I/O) interfaces. Varying software can include certain programming languages, operating systems, and so forth. Dependency data or call graphs can indicate data dependencies among microservices to indicate which microservices produce data and which microservices process data and from what microservices. A call graph can represent a consistent dependency chain of individual nodes (e.g., μNetFns) or microservices. However, dependency data may not be compatible with platforms that execute microservices and sidecars executed on a platform may not be able to properly read dependency data. At least to address inconsistencies and varying platform software and hardware, a controller in a platform can translate dependency data or a call graph into semantics interpretable by the side car. For example, a call graph can be implemented as Graphviz, a .dot format file, and a controller can utilize tools can be used to transform .dot file into JSON, YAML, TOML, or other formats accessible to a side car that is to access the call graph.

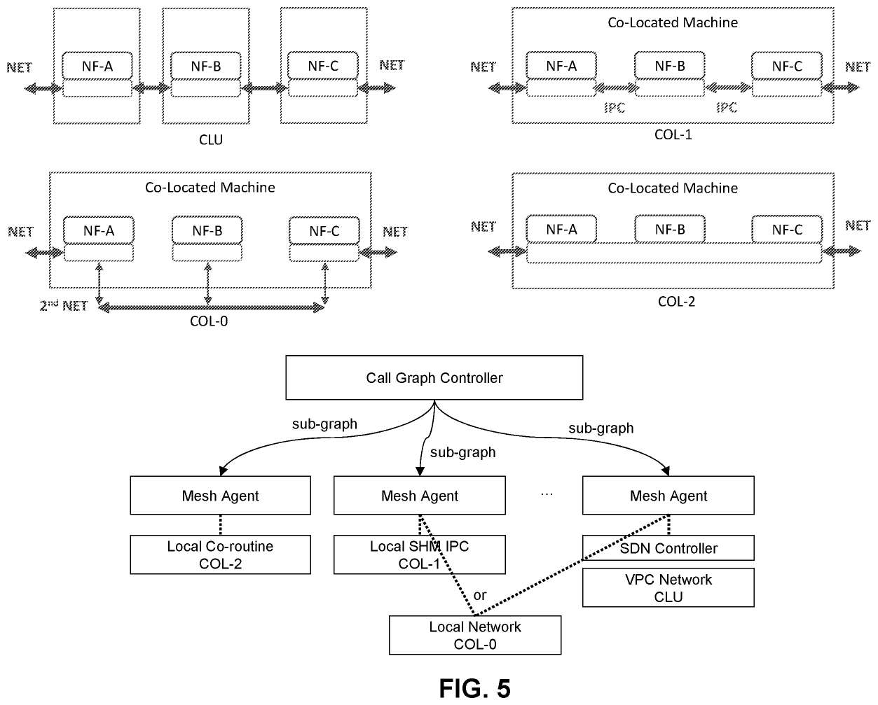

FIG. 5 depicts an example of services deployments based on call graphs. Network functions (NF-A to NF-C) can be deployed in co-located machines or clusters. For example, CLU can represent a cluster. In a cluster, network functions NF-A, NF-B, and NF-C can communicate using networking (e.g., Ethernet packets) and memory can be accessed using packets. For example, co-located machine deployments can include COL-0, COL-1, and COL-2. For example, in COL-0, NF-A, NF-B, and NF-C can execute in a same server and memory associated with NF-A, NF-B, and NF-C can be accessed using a network fabric (e.g., embedded switch or network interface device). For example, in COL-1, NF-A, NF-B, and NF-C are individual processes that execute on a same server and share memory and can communicate using inter-process communication (IPC) and use networking to communicate with other processes in another server. For example, in COL-2, NF-A, NF-B, and NF-C are executed by a single process that executes in a server and memory associated with NF-A, NF-B, and NF-C can be accessed using a mesh fabric as memory and memory address spaces can be shared among NF-A, NF-B, and NF-C.

A developer can independently compose a call graph that indicates dependencies among services. A call graph controller can provide a distributed call graph configuration to platforms in CLU or COL deployments. Call graph controller can split the graph into two or more sub-graphs according to the deployment of services on different systems. For example, for deployments of operations among COL-0, COL-1, COL-2, and CLU, the call graph controller can issue sub-graphs to COL-0, COL-1, COL-2, and CLU. Mesh agents (e.g., DMF 302) can execute on different systems can receive a sub-graph from the call graph controller. Sub-graphs can indicate dependencies among services executes on COL-0, COL-1, COL-2, and CLU.

In a CLU deployment, mesh agent can leverage software-defined networking (SDN) controller for an overlay Virtual Private Cloud (VPC) network fabric setup to attach a network interface to service instances. In COL-1 deployment, a mesh agent can create a shared memory IPC channel and attach a network interface to another service instance such as a peer service. In COL-0 deployment, an operator can choose either of the former two mesh agents of CLU or COL-1 for communications among services. COL-2 can include an in-process mesh fabric to host various service instances. Mesh agents can translate depedencies in received sub-graphs for utilization on a target platform.

Meta-data can be used to carry data to and from CLU, COL-0, COL-1, and COL-2 to provide data to dependent μNetFns. Meta-data can be defined using specifications for data communications. Examples of meta-data include gRPC's protobuf gRPC, Restful OpenAPI, and others. In a case of a local function call, buffer descriptor carries the meta-data in zero-copy manner by providing pointers to memory addresses. In a case of networking, the network protocol (e.g., SRv6 Seg) and network interface associate the meta-data within a packet by network service header (NSH).

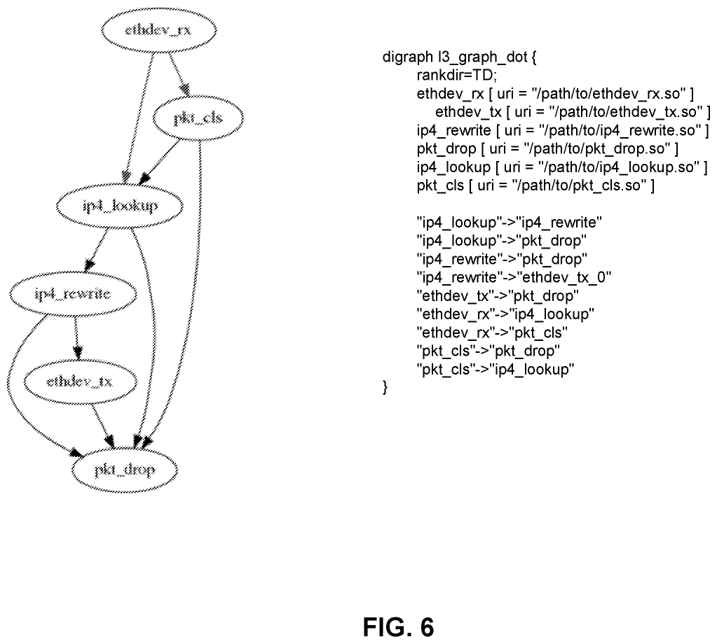

FIG. 6 depicts an example of 13fwd call graph. It uses graph edge to represent the dependency and uses node with a few pre-defined attributes to represent an individual service function.

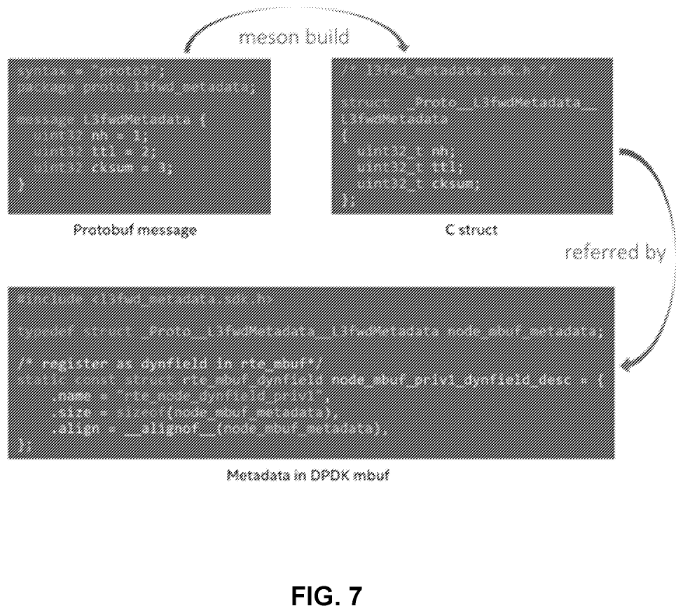

FIG. 7 shows an example use of protobuf to transmit meta-data. Protobuf message translated using meson build to C struct. C struct included in packet header descriptor. It leverages existing protobuf tools chain to translate spec file to the meta-data prototype. As protype output of protobuf considers serialization and transportation, which are not required for meta-data, a tool can remove them from the meta-data protype. Based on creation of a protype of meta-data, a wrapper is designed to carry meta-data within buffer descriptor (e.g., mbuf).

A μNetFn can be deployed for execution on different platforms that utilize different thread models. A μNetFn can be platform agnostic whereby an applied thread modeling can be utilized in a runtime of a single or multi-core processor. For example, run-to-completion is a thread model to complete an entire task within a core. Another example thread modeling approach is pipeline mode that utilizes multiple cores to complete a task. Other examples of thread models include single thread, multiple thread, or each thread per core.

During compiling of a μNetFn and prior to deployment of the μNetFn, an applicable thread model that will execute binary of the μNetFn may not be determined until selection of a platform to execute the μNetFn. Features of the platform that is to execute the μNetFn can include core count and thread model. Various examples utilize a binding mechanism that defers thread model binding into the runtime stage based on platform on which the μNetFn is to be deployed. A μNetFn can be remapped to a target deployment based on target thread model.

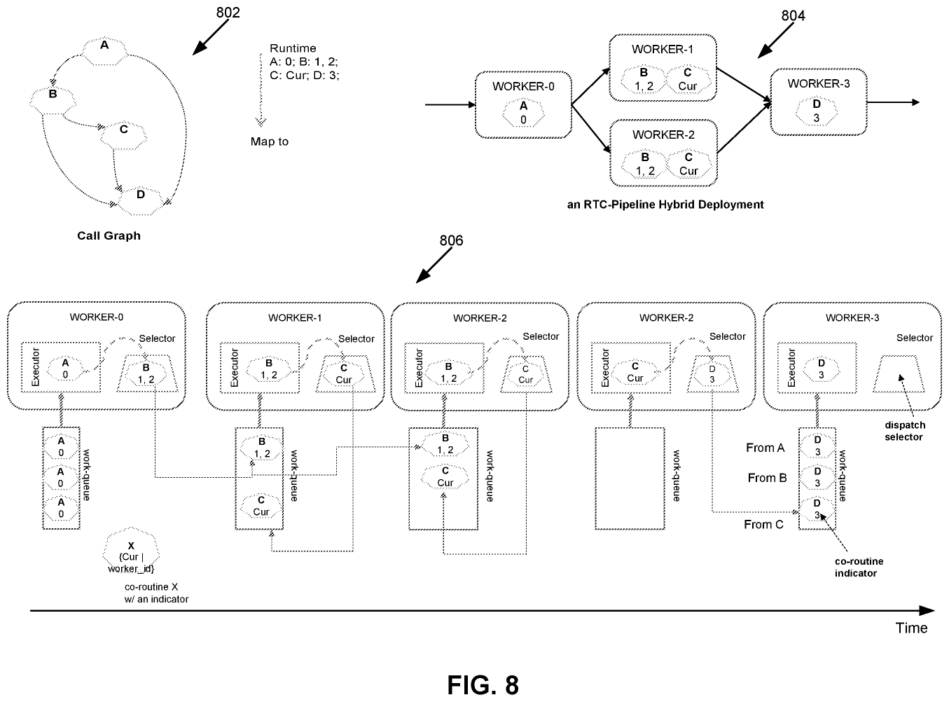

FIG. 8 depicts an implementation of dependent services. Call graph 802 can include dependencies among services (μNetFns) A, B, C, and D. As shown, B can be dependent on data from A, C can be dependent on data from B, whereas D can be dependent on data from B, C, and A.

Deployment 804 depicts a hybrid deployment of RTC and pipeline thread models. For example, {B, C} can apply a RTC model and A->{B, C}->D can apply a pipeline model.

A, B, C, and D can be associated with an executable binary (e.g., dynamic library or byte code) and an indicator of a logical core to execute a service (e.g., WORKER). A logical core can be represented by a number of physical cores and number of threads that execute on the number of physical cores to provide a WORKER (e.g., WORKER-0, WORKER-1, WORKER-2, WORKER-3, and so forth). Indicator values can be based on a call graph. For example, indicator value of 0 can indicate execute binary on WORKER-0 (e.g., logical core 0). For example, indicator value of 1.2 can indicate execute binary on WORKER-1 or WORKER-2. For example, indicator value of Cur can indicate use indicator value from parent. Services A-D have associated indicators that indicate workers that can perform the services. A can be executed by WORKER-0, B can be executed by WORKER-1 or WORKER-2, C can be executed by a same worker as that of a parent (e.g., B). In this example, the sole parent of C is B and indicator value of B is 1.2. D has an indicator value of 3 and can be executed by WORKER-3.

A non-preemptive (e.g., does not interrupt and change to another task) scheduler (SC) (e.g., DMF and/or executor and selector) can utilize co-routine indicator and a dispatch selector in order to select a service to execute on a particular worker. SC can be associated with a worker (e.g., logical core) whose context has a copy of a call graph. Deferred thread model binding at runtime can map the call graph into 4 workers (WORKER-0 to WORKER-3).

Sequence 806 depicts an example of execution of binaries A-D. WORKER-0 executes a binary for A. After A is finished, A can call B by configuring selector running on WORKER-0 to read indicator of B. Selector running on WORKER-0 can dispatch B on WORKER specified by indicator B, namely, WORKER-1 or WORKER-2, by placing the B into a work queue associated with WORKER-1 or WORKER-2. In this example, selector running on WORKER-0 places the B into work queue associated with WORKER-1. After completion of C by WORKER-2, WORKER-2 can place D with indicator of 3 into work queue for WORKER-3. In this example, as D has dependencies on data from A, B, and C, then A, B, and C can provide D with indicator 3 in work queue for WORKER-3.

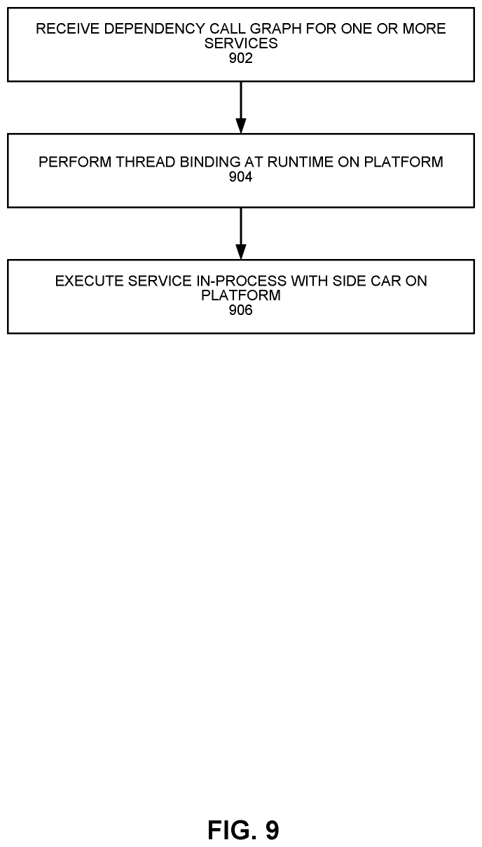

FIG. 9 depicts an example process. The process can be performed by a platform to deploy services for execution on one or more processors. At 902, a dependency call graph can be received at the platform that is to execute microservices. The dependency call graph can indicate a data dependency of a service with one or more other services. For example, the service can access data from one or more other services and/or provide data for processing by one or more other services. In some examples, the dependency call graph can be sent from a call graph controller to the platform. In some examples, the platform can translate the dependency call graph to a format supported by the platform. At 904, at runtime stage, a thread model binding can be applied to the service based on a platform of deployment. For example, instead of during a service compilation stage, a thread model binding can be applied to the service during runtime of the service on one or more processors of the platform. At 906, the service can be executed in-process with a sidecar. For example, the service can be executed with a sidecar on one or more logical cores to share memory and cache.

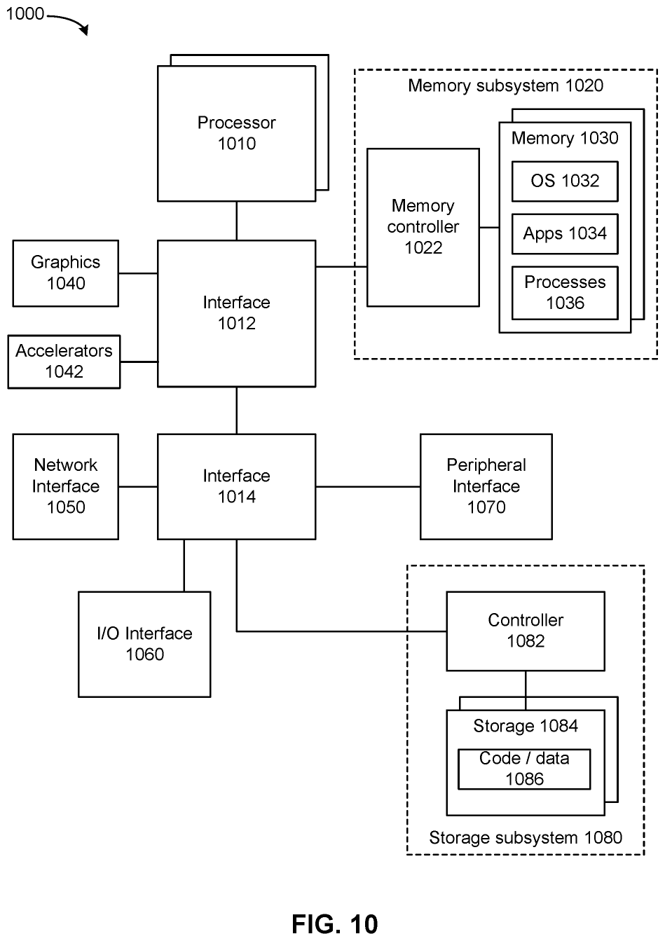

FIG. 10 depicts a system. System 1000 can be included in a server that is part of a data center. Components of system 1000 can be utilized to execute services in-process with a side car on circuitry with dependencies with other services based on a dependency graph data, as described herein. System 1000 includes processor 1010, which provides processing, operation management, and execution of instructions for system 1000. Processor 1010 can include any type of microprocessor, central processing unit (CPU), graphics processing unit (GPU), XPU, processing core, or other processing hardware to provide processing for system 1000, or a combination of processors. An XPU can include one or more of: a CPU, a graphics processing unit (GPU), general purpose GPU (GPGPU), and/or other processing units (e.g., accelerators or programmable or fixed function FPGAs). Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a display that provides an output to a user. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a programmable or fixed function offload engine that can be accessed or used by a processor 1010. For example, an accelerator among accelerators 1042 can provide data compression (DC) capability, cryptography services such as public key encryption (PKE), cipher, hash/authentication capabilities, pattern detection, direct memory access data copying, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

Applications 1034 and/or processes 1036 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)).

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 1050.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. In some examples, network interface 1050 or network interface device 1050 can refer to one or more of: a network interface controller (NIC), a remote direct memory access (RDMA)-enabled NIC, SmartNlC, router, switch (e.g., top of rack (ToR) or end of row (EoR)), forwarding element, infrastructure processing unit (IPU), or data processing unit (DPU). An example IPU or DPU is described at least with respect to FIG. 12.

In some examples, network interface 1050 can include packet processing circuitry that can implement a pipeline of match-action operations. Packet processing circuitry can be programmed by one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014. A volatile memory is memory whose state (and therefore the data stored in it) is indeterminate if power is interrupted to the device. A non-volatile memory (NVM) device is a memory whose state is determinate even if power is interrupted to the device.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. A die-to-die communications can utilize Embedded Multi-Die Interconnect Bridge (EMIB) or an interposer.

In an example, system 1000 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

FIG. 12 depicts an example system. In this system, IPU 1200 manages performance of one or more processes using one or more of processors 1206, processors 1210, accelerators 1220, memory pool 1230, or servers 1240-0 to 1240-N, where N is an integer of 1 or more. In some examples, processors 1206 of IPU 1200 can execute one or more processes, applications, VMs, containers, microservices, and so forth that request performance of workloads by one or more of: processors 1210, accelerators 1220, memory pool 1230, and/or servers 1240-0 to 1240-N. IPU 1200 can utilize network interface 1202 or one or more device interfaces to communicate with processors 1210, accelerators 1220, memory pool 1230, and/or servers 1240-0 to 1240-N. IPU 1200 can utilize programmable pipeline 1204 to process packets that are to be transmitted from network interface 1202 or packets received from network interface 1202.

In some examples, programmable pipelines 1204 can be programmed using one or more control planes executing on one or more processors (e.g., one or more of processors 1206) based on approval of the configuration or the configuration can be denied, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes: at least one non-tangible computer-readable medium comprising instructions stored thereon, that if executed by one or more processors on a platform, cause the one or more processors on the platform to: receive dependency data for at least one process, wherein the dependency data is to indicate data dependency between the at least one process and a second process; determine a thread model for execution of the at least one process by the one or more processors; and during runtime of the at least one process, cause the one or more processors to execute the at least one process according to the determined thread model and in-process with a sidecar, wherein the sidecar is to communicate with a service mesh to communicate with one or more microservices of a cloud native application.

Example 2 includes one or more examples, wherein the second process is to execute on a different platform than that of the platform and the different platform is coupled to the platform using a network.

Example 3 includes one or more examples, wherein the second process is to execute on a different processor than the one or more processors.

Example 4 includes one or more examples, wherein to execute the at least one process in-process with a sidecar, the process and sidecar are to execute on a same core, same process, and/or same container.

Example 5 includes one or more examples, wherein the at least one process is to perform a network function.

Example 6 includes one or more examples, wherein the network function comprises one or more of: firewall, load balancer, Network Address Translation (NAT), or gateway.

Example 7 includes one or more examples, wherein the at least one process in-process with the sidecar comprises the at least one process and the sidecar are to execute on a same core and share memory and cache.

Example 8 includes one or more examples, wherein the one or more processors is to translate dependency data to a format for processing by the platform.

Example 9 includes one or more examples, wherein the at least one process has an associated indicator of logical core permitted to execute the at least one process and wherein the indicator is based on the dependency data.

Example 10 includes one or more examples and includes an apparatus comprising: a memory comprising instructions stored thereon and at least one processor, that based on execution of the instructions stored in the memory, is to: cause transmission of a request to at least one platform to execute multiple services, wherein the multiple services utilize data according to a data dependency relationship; cause transmission of a dependency graph, based on the data dependency relationship, to the at least one platform; and cause the at least one platform to: execute at least one of the multiple services on a processor that executes a side car and to share memory between the at least one of the multiple services and the side car and to set a thread binding model at runtime of the at least one of the multiple services.

Example 11 includes one or more examples, wherein the at least one of the multiple services is to execute on a different platform than that of at least one other of the multiple services.

Example 12 includes one or more examples, wherein the at least one of the multiple services is to execute on a different processor than that of at least one other of the multiple services.

Example 13 includes one or more examples, wherein the at least one of the multiple services is to execute on a same processor as that of at least one other of the multiple services.

Example 14 includes one or more examples, wherein the at least one platform comprises a cluster and/or co-located machines.

Example 15 includes one or more examples, wherein the sidecar is to provide communications among different services of the multiple services.

Example 16 includes one or more examples, wherein the at least one processor, based on execution of the instructions stored in the memory, is to: cause the at least one platform to translate the dependency graph to a format for processing by the at least one platform.

Example 17 includes one or more examples, wherein the at least one processor, based on execution of the instructions stored in the memory, is to: provide an indicator of at least one logical core permitted to execute at least one of the multiple services and wherein the indicator is based on the dependency graph.

Example 18 includes one or more examples and includes a method comprising: executing at least one process according to a thread model and in-process with a sidecar, wherein the thread model is set for the at least one process during runtime of the at least one process.

Example 19 includes one or more examples, wherein the at least one process is to perform a network function and wherein the network function comprises one or more of: firewall, load balancer, Network Address Translation (NAT), or gateway.

Example 20 includes one or more examples, wherein the at least one process is allocated to a processor based on dependency data.

Example 21 includes one or more examples, wherein the at least one process is executed on at least one platform comprising a cluster and/or co-located machines.

What is claimed is:

1. At least one non-tangible computer-readable medium comprising instructions stored thereon, that if executed by one or more processors on a platform, cause the one or more processors on the platform to:
receive dependency data for at least one process, wherein the dependency data is to indicate data dependency between the at least one process and a second process;
determine a thread model for execution of the at least one process by the one or more processors; and
during runtime of the at least one process, cause the one or more processors to execute the at least one process according to the determined thread model and in-process with a sidecar, wherein the sidecar is to communicate with a service mesh to communicate with one or more microservices of a cloud native application.

2. The at least one computer-readable medium of claim 1, wherein the second process is to execute on a different platform than that of the platform and the different platform is coupled to the platform using a network.

3. The at least one computer-readable medium of claim 1, wherein the second process is to execute on a different processor than the one or more processors.

4. The at least one computer-readable medium of claim 1, wherein to execute the at least one process in-process with a sidecar, the process and sidecar are to execute on a same core, same process, and/or same container.

5. The at least one computer-readable medium of claim 1, wherein the at least one process is to perform a network function.

6. The at least one computer-readable medium of claim 5, wherein the network function comprises one or more of: firewall, load balancer, Network Address Translation (NAT), or gateway.

7. The at least one computer-readable medium of claim 1, wherein the at least one process in-process with the sidecar comprises the at least one process and the sidecar are to execute on a same core and share memory and cache.

8. The at least one computer-readable medium of claim 1, wherein the one or more processors is to translate dependency data to a format for processing by the platform.

9. The at least one computer-readable medium of claim 1, wherein the at least one process has an associated indicator of logical core permitted to execute the at least one process and wherein the indicator is based on the dependency data.

10. An apparatus comprising:
a memory comprising instructions stored thereon and
at least one processor, that based on execution of the instructions stored in the memory, is to:
cause transmission of a request to at least one platform to execute multiple services, wherein the multiple services utilize data according to a data dependency relationship;
cause transmission of a dependency graph, based on the data dependency relationship, to the at least one platform; and
cause the at least one platform to: execute at least one of the multiple services on a processor that executes a side car and to share memory between the at least one of the multiple services and the side car and to set a thread binding model at runtime of the at least one of the multiple services.

11. The apparatus of claim 10, wherein the at least one of the multiple services is to execute on a different platform than that of at least one other of the multiple services.

12. The apparatus of claim 10, wherein the at least one of the multiple services is to execute on a different processor than that of at least one other of the multiple services.

13. The apparatus of claim 10, wherein the at least one of the multiple services is to execute on a same processor as that of at least one other of the multiple services.

14. The apparatus of claim 10, wherein the at least one platform comprises a cluster and/or co-located machines.

15. The apparatus of claim 10, wherein the sidecar is to provide communications among different services of the multiple services.

16. The apparatus of claim 10, wherein the at least one processor, based on execution of the instructions stored in the memory, is to:
cause the at least one platform to translate the dependency graph to a format for processing by the at least one platform.

17. The apparatus of claim 10, wherein the at least one processor, based on execution of the instructions stored in the memory, is to:
provide an indicator of at least one logical core permitted to execute at least one of the multiple services and wherein the indicator is based on the dependency graph.

18. A method comprising:
executing at least one process according to a thread model and in-process with a sidecar, wherein the thread model is set for the at least one process during runtime of the at least one process.

19. The method of claim 18, wherein the at least one process is to perform a network function and wherein the network function comprises one or more of: firewall, load balancer, Network Address Translation (NAT), or gateway.

20. The method of claim 18, wherein the at least one process is allocated to a processor based on dependency data.

21. The method of claim 18, wherein the at least one process is executed on at least one platform comprising a cluster and/or co-located machines.
